(19) United States
(12) Patent Application Publication
(10) Pub. No.: US 2012/0006251 A1
(43) Pub. Date: Jan. 12, 2012

(54) FLUID LEVEL INDICATOR DEVICE

(76) Inventor: Bradley Ray Kiefer, Ogden, IA (US)

(21) Appl. No.: 13/175,984

(22) Filed: Jul. 5, 2011

Related U.S. Application Data
(60) Provisional application No. 61/361,596, filed on Jul. 6, 2010.

(51) Int. Cl. G01F 23/30

(52) U.S. Cl. 116/228

(57) ABSTRACT

A fluid level indicator device that attaches to a fluid fill nozzle of an existing fluid tank is disclosed. The device is comprised of a frame assembly that removably attaches to the fluid fill nozzle and a float assembly that is attached to the frame assembly. The first embodiment is comprised of a frame assembly that springingly and snugly fits in the interior of the fluid tank. In a second embodiment, the frame assembly is comprised of an angular hollow tube and a threaded slip that attaches the angular hollow tube to the fluid fill nozzle, and a narrow hollow tube that accommodates the float assembly. In the embodiments presented herein, the level for the float assembly visible above the top of the frame assembly indicates the relative level of the fluid in the tank. Various embodiments add indicia to the float assembly and set the relative fluid level to be the actual fluid level.

### CROSS-REFERENCE TO RELATED APPLICATIONS

This application claims the benefit of the U.S. Provisional Patent Application No. 61/361,596 filed Jul. 6, 2010 by the present inventor. This provisional patent application is incorporated herein by reference.

### TECHNICAL FIELD

This invention relates to fluid level indicators. More particularly, it relates to a fluid level indicator that removably attaches to the fuel fill nozzle of a fuel tank installed on mobile equipment such as lawnmowers or snow blowers.

### BACKGROUND OF THE DISCLOSURE

There exists many devices that address the problem of determining the fluid level of an opaque vessel such as a fuel tank when filling it with a liquid. For fluid level indicator devices designed for use with a small portable fuel tank such as found on small engine powered mobile equipment like a lawn mower or snow blower, the existing fluid level indicators often fall into one of three general groups. The first group use funnels having an embedded float. The funnel is inserted in the opening of the fuel fill nozzle of a fuel tank when adding or measuring the fuel level of the fuel tank, and removed when the cap of the fuel fill nozzle is installed. U.S. Pat. No. 530,690, “Funnel” by H. G. James, issued Dec. 11, 1894 is an example of a patent falling in this group. The second group has the fluid level indicator device installed permanently on the fuel tank but positioned away from the fuel fill nozzle. US patent publication 20030000304, “Magnetically Operated Fuel Gauge” by Clyde R. Wetor, published Jan. 2, 2003 is an example from this group. The third group has the fluid level indicator device built into the gas cap. U.S. Pat. No. 4,724,706, “Fuel Tank Gauge” by Michael E. Stiever, patented Feb. 16, 1998 is an example from this group.

### SUMMARY OF THE DISCLOSURE

The fluid level indicator device described herein apply to fluid containing vessels in general; however for exposition purposes the discussion is restricted to fluid tanks such as fuel tanks for lawnmowers and snow blowers. The ideal fluid level indicator device has a simple design, is cheap to manufacture, and may be sold as an aftermarket product fitting vessels such as fuel tanks with different size fuel fill nozzles. Furthermore it can be kept on the fuel tank when fuel is added, while the engine powered mobile equipment is in use such as for cutting grass, and when the mobile equipment is put in storage. It also serves a significant safety function: it helps prevent overflow of fluid from the tank. The fluid level indicator embodiments of the invention presented herein satisfy these requirements.

The several embodiments of the fluid level indicator device presented herein are each comprised of a frame assembly and a float assembly. In the first embodiment of the present invention, the frame assembly is comprised of a curved rectangular strip made of a springy material that snugly fits in the interior of a fluid tank fluid fill nozzle, tabs that enable the top of the curved rectangular strip to be positioned on the top of the fluid fill nozzle, and a guide attached to the curved rectangular strip. The float assembly has a shaft with a float attached to the bottom. The shaft is slidingly attached to the guide. When the float shaft is pushed down to its maximum amount, the fluid tank cap may be put on the fluid tank nozzle. When the fuel tank cap is removed, the float assembly floats, indicating the relative level of the fluid in the tank.

In the second embodiment of the present invention, the frame assembly is comprised of an angular hollow tube threaded on the top end, a threaded slip that removably connects the angular hollow tube to the threads of the fluid tank nozzle, and a narrow hollow tube mounted vertically on the angular hollow tube with an opening that accommodates the shaft of the float assembly. The narrow hollow tube is positioned in the angular hollow tube so that a nozzle from a fluid can fits in the opening of the angular hollow tube without interfering with the float assembly. The second embodiment is installed on the fluid fill nozzle and the fluid tank gas cap is installed on the angular hollow tube threaded on the top end. For the second embodiment, the float assembly continually determines the relative level of the fluid in the tank. Additional embodiments are presented.

### BRIEF DESCRIPTION OF THE DRAWINGS

FIG. 1 illustrates a perspective view of a typical fluid tank.

FIG. 2 illustrates a perspective view of an overview of a first embodiment of the present invention installed in the fluid fill nozzle of a fluid tank.

FIG. 3 illustrates an exploded view of the components comprising the first embodiment of the present invention.

FIG. 4 illustrates an assembled perspective view of the first embodiment of the present invention.

FIG. 5 illustrates the two assemblies: the first frame assembly and the float assembly of the first embodiment of the present invention.

FIG. 6 illustrates a sectional view shown in an expanded scale of the first embodiment of the present invention.

FIG. 7 illustrates a second embodiment of the present invention.

FIG. 8 illustrates the two assemblies: the second frame assembly and the float assembly of the second embodiment of the present invention.

FIG. 9 illustrates a sectional view of the second embodiment of the present invention. [0015] [0016].

FIG. 10 illustrates the second embodiment of the present invention installed on a fluid tank such as a lawnmower fuel tank.

FIG. 11 illustrates a sectional view of a detail of FIG. 9

FIG. 12 illustrates a third embodiment of the present invention.

FIG. 13 illustrates the addition of indicia to the third embodiment of the present invention.

FIG. 14 illustrates an exploded perspective view of a fourth embodiment of the present invention.

FIG. 15 illustrates an assembled perspective view of the fourth embodiment of the present invention.

### DETAILED DESCRIPTION

In the following description and claims, the terms top, bottom, left, right vertical, horizontal and similar terms are interpreted relative to the figure they reference. The term “fluid” is used in the description below, however the embodiments have particular relevance to fuel tanks such as found on lawnmowers of snow blowers.

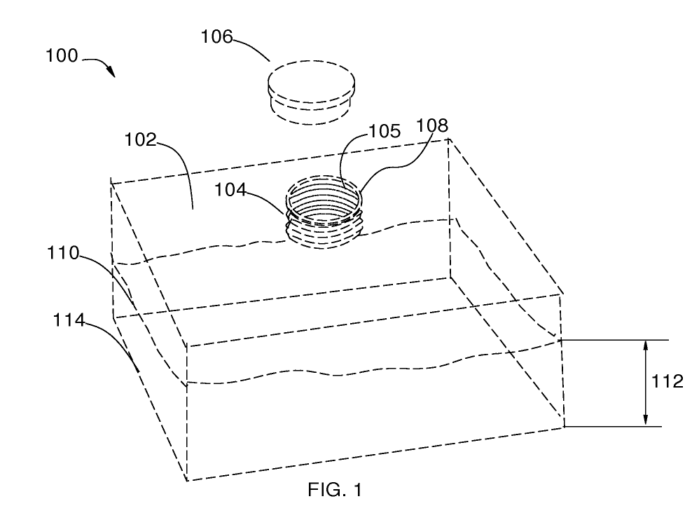

FIG. 1 illustrates a fluid tank 100 for holding liquids such as gasoline typically found on a mobile engine driven device such as lawnmowers, snow blowers, and electric generators. Fluid tank 100 is comprised of a fluid container 102, a fluid fill nozzle 104 located at the top of fluid container 102 and a threaded cap 106. Fluid fill nozzle 104 has a nozzle interior surface 105 and a fluid fill nozzle rim 108. Fluid fill nozzle 104 allows fluid to be poured into fluid container 102. FIG. 1 shows fluid with the fluid surface 110 located in fluid container 102. The actual fluid level 112 of fluid in fluid tank 100 is defined herein as the distance between the top of the fluid surface 110 and the tank bottom interior surface 114 of fluid tank base. The fluid tank 100 is not part of the present invention.

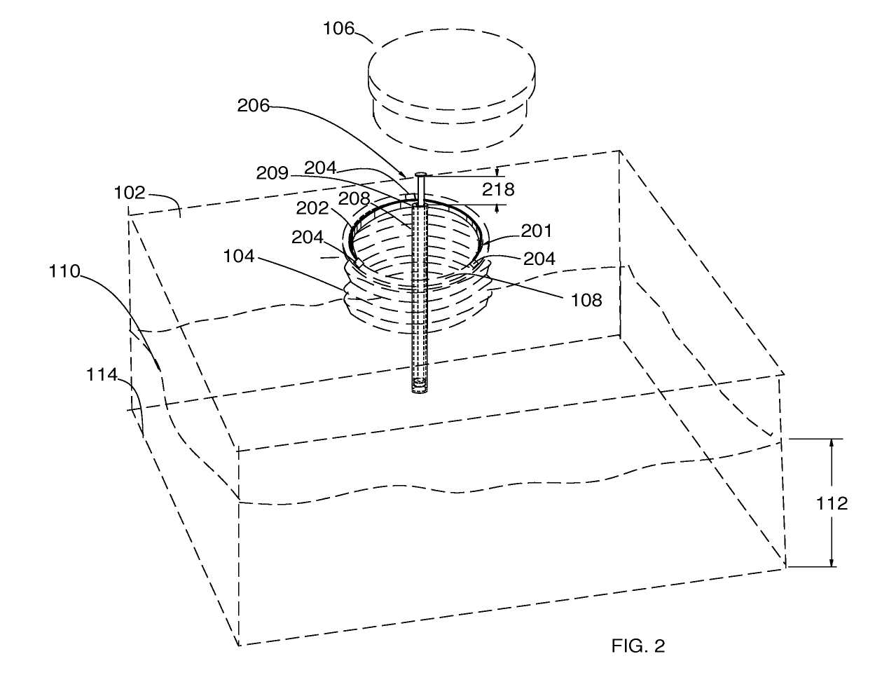

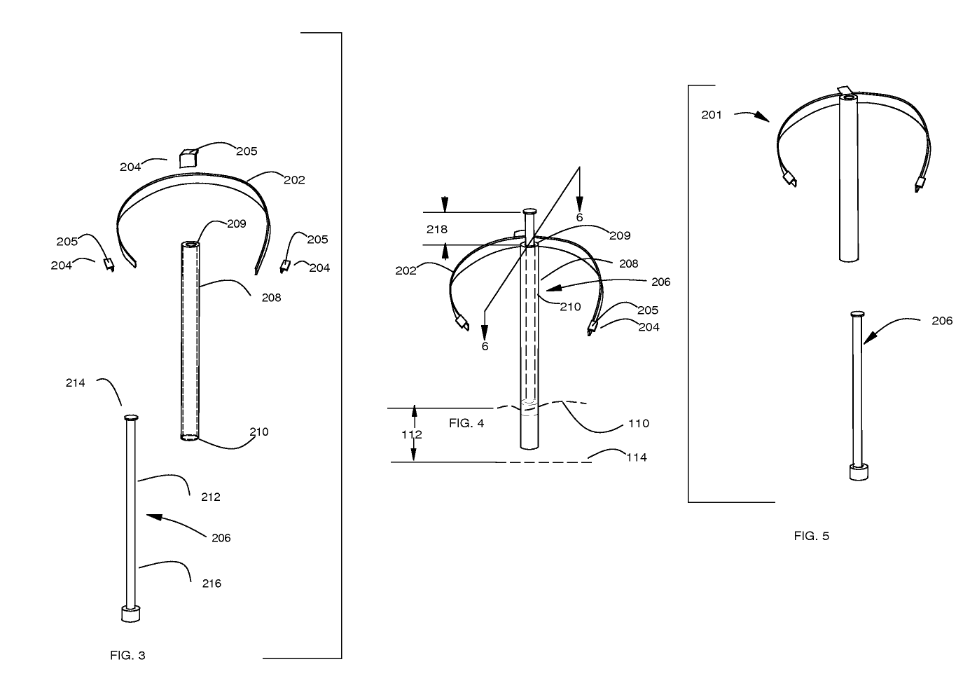

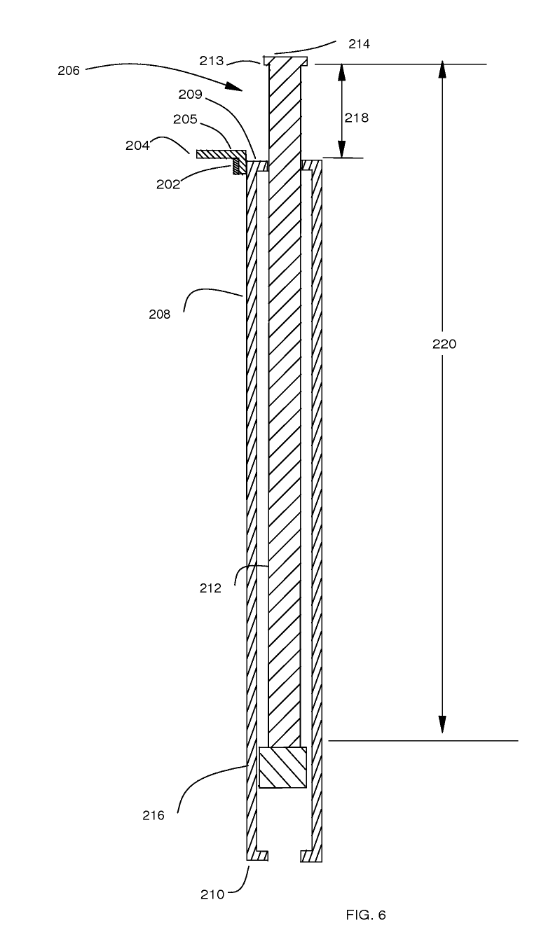

FIG. 2 illustrates an overview of a first embodiment of the present invention installed in fluid fill nozzle 104 of fluid tank 100. FIG. 3 illustrates an exploded view of the components comprising the first embodiment. FIG. 4 illustrates an assembled perspective view of the first embodiment. FIG. 5 illustrates the two assemblies comprising the first embodiment: the first frame assembly 201 and the float assembly 206. FIG. 6 illustrates a sectional view shown in an expanded scale of the first embodiment; the section taken as indicated in FIG. 4.

Referring to FIGS. 2 through 6, the first embodiment is comprised of a first frame assembly 201 and a float assembly 206. First frame assembly 201 is comprised of a curved rectangular strip 202 shaped as a section of a hollow cylinder with three tabs 204 joined to curved rectangular strip 202, and a guide 208 with two guide lips, guide upper lip 209 and guide lower lip 210. Tabs 204 each has a tab horizontal surface 205 adapted to rest on the fluid fill nozzle rim 108 of fluid fill nozzle 104. Guide 208 slidingly secures float assembly 206. Curved rectangular strip 202 is made of a spring-like material manufactured so it tends to return to its shape when deformed. Curved rectangular strip 202 is sized and configured so that when curved rectangular strip 202 is inserted in fluid fill nozzle 104, it causes curved rectangular strip 202 to fit snugly and securely against the nozzle interior surface 105 of fluid fill nozzle 104 with the three tabs 204 resting on the fluid fill nozzle rim 108 of fluid fill nozzle 104.

Again referring to FIGS. 2 through 6, float assembly 206 is comprised of a shaft 212 with a crown 214 having a shaft lip 213 located at the top of shaft 212 and a float 216 located at the bottom of shaft 212. Shaft 212 and float 216 are made of a lightweight materiel so that float 216 floats close to the fluid surface 110. Guide 208 is joined to curved rectangular strip 202 so that guide upper lip 209 lies approximately coplanar with top of curved rectangular strip 202. Float assembly 206 slides within guide 208 but is constrained by shaft lip 213 from separating from guide 208.

Float assembly 206 is constructed out of materials so that when embodiment one is inserted in fluid tank 100 as indicated in FIG. 2, float assembly 206 rises as fluid is added to the tank and descends when fluid is removed. The shaft length 220 of shaft 212 is a design option. A smaller value of shaft length 220 of shaft 212 will allow the first embodiment to indicate when fluid added to fluid container 102 is approaching its capacity. A larger value of shaft length 220 will indicate when fluid container 102 is both close to being filled or being almost empty. As indicated in FIGS. 2 and 4, actual fluid level 112 is the distance between the top of the fluid surface 110 and the tank bottom interior surface 114 of fluid tank base. The relative fluid level 218 is defined to be the portion of shaft 212 between crown 214 and guide upper lip 209. This portion is observable by a user. The relative fluid level 218 depends on the quantity of fluid in the container and is a measure of the actual fluid level 112. The first embodiment is installable on fluid tank 100 by removing threaded cap 106, inserting the curved rectangular strip 202 into fluid fill nozzle 104 until three tabs 204 rest on the fluid fill nozzle 104. The relative fluid level 218 will differ from the actual fluid level 112 by a fixed bias, independent of the amount of fluid in the tank.

The first embodiment operates as follows: When the first embodiment is installed in fluid tank 100 as indicated in FIG. 2 with threaded cap 106 removed, float assembly 206 will rise or descend depending on the height of the fluid surface 110 that determines the actual fluid level 112 of the fluid in the fluid container 102. As fluid is added to or removed from the tank, the actual fluid level 112 indicates the amount of fluid in the container. The relative fluid level 218 is defined to be the distance between the crown 214 and the guide upper lip 209. When the fluid tank 100 is put in storage, the float assembly 206 is lowered and threaded cap 106 is screwed onto fluid fill nozzle 104.

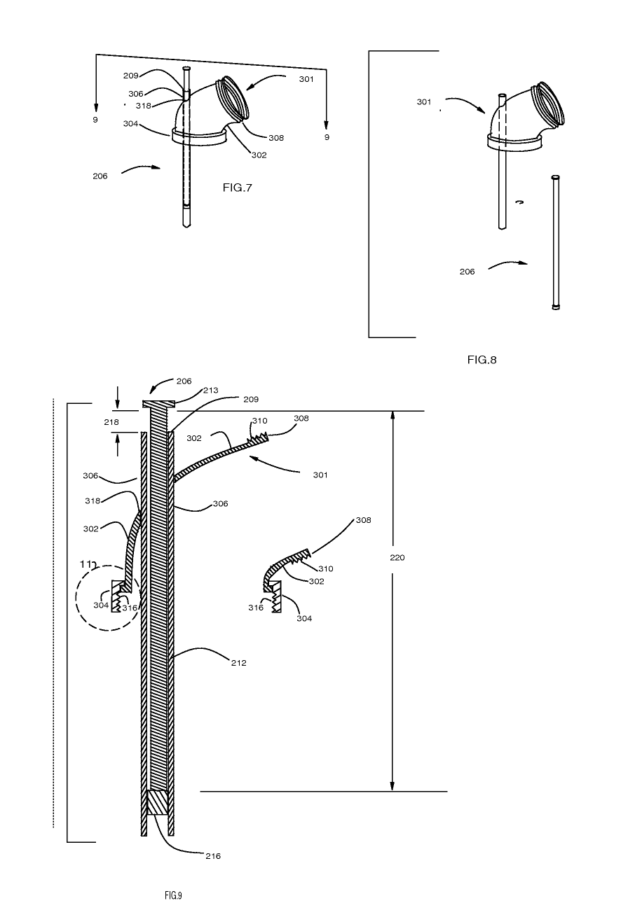

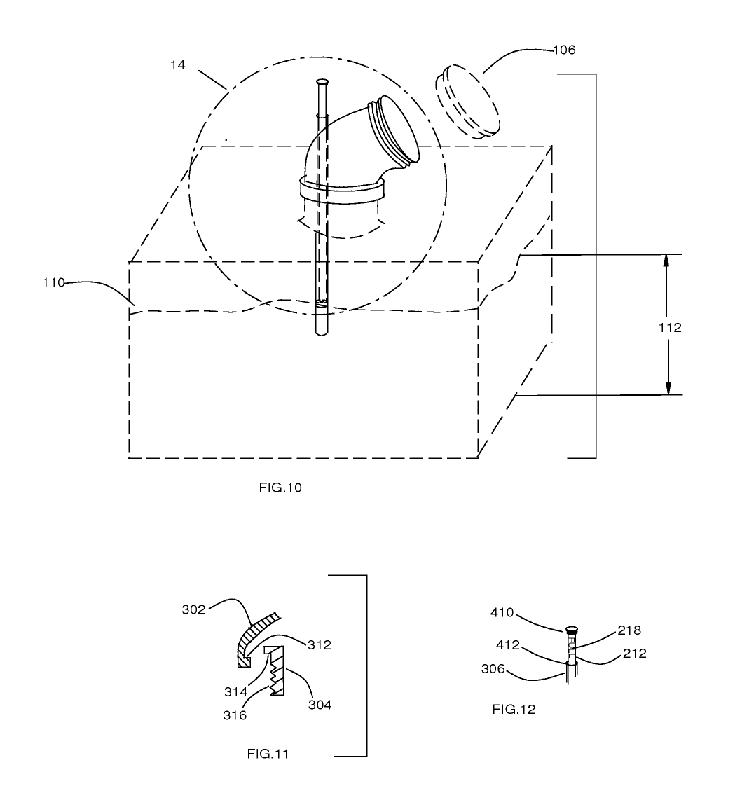

FIG. 7 illustrates a second embodiment of the present invention. FIG. 8 illustrates the two assemblies of the second embodiment: the second frame assembly 301 and the float assembly 206. FIG. 9 illustrates a sectional view of the second embodiment, drawn in an expanded scale. FIG. 10 illustrates the second embodiment installed on fluid tank 100. FIG. 11 illustrates a sectional view of a detail of FIG. 9.

Referring to FIGS. 7 through 11, the second embodiment is comprised of a second frame assembly 301 and a float assembly 206. Second frame assembly 301 is comprised of an angular hollow tube 302, a threaded slip 304, and a narrow hollow tube 306 mounted vertically and passing through angular hollow tube 302 and functioning as a guide 208 with a guide upper lip 209. Float assembly 206 has the same parts and structure as described in the first embodiment and fluid tank 100 and its parts are described in FIG. 1 and the associated text.

Again referring to FIGS. 7 through 11, angular hollow tube 302 has an angular tube top end 308 having angular tube external threads 310 adapted to fit threaded cap 106, and a tube lip 312 adapted to mate with a slip lip 314 located on top of threaded slip 304. Threaded slip 304 has internal threads 316 adapted to fit the threads located on fluid fill nozzle 104. Narrow hollow tube 306 is rigidly mounted on angular hollow tube 302 protruding through an aperture 318 located on angular hollow tube 302, so that shaft 212 of float assembly 206 slidingly passes through. The second embodiment is sized and configured so that threaded slip 304 screws snugly on fluid fill nozzle 104. The second embodiment is installable on fluid tank 100 by removing threaded cap 106, and screwing the threaded slip 304 on fluid fill nozzle 104. The relative fluid level 218 is the portion of shaft 212 between guide upper lip 209 and crown 214. Relative fluid level 218 is observable by a user.

The second embodiment may also have a multiple set of threaded slips 304. Each of the threaded slip 304 fits on angular hollow tube 302, and is configured to be compatible with a different fluid fill nozzle 104 found on commercially available products. Therefore, the second embodiment, sold with a set of threaded slips 304, will fit a variety of commercially available fluid tanks. The set of threaded slips 304 are not shown in the figures.

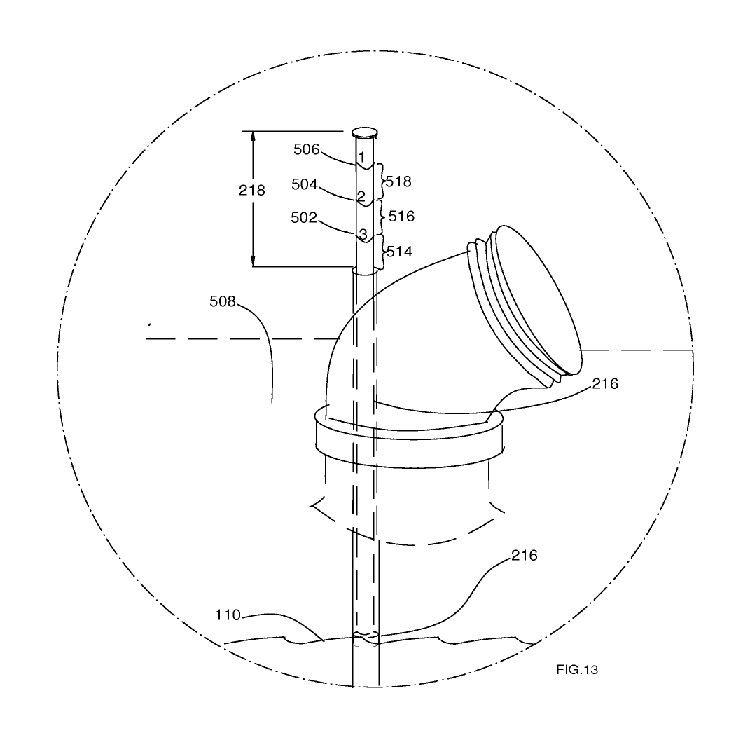

FIG. 12 illustrates a third embodiment, a variation of the second embodiment. The third embodiment has a first male set of threads 410 positioned near top of shaft 212 and a first female set of threads 412 that mates with first male set of threads 410. First female set of threads 412 is positioned on top interior of guide 208. This permits float assembly 206 to be secured in its lowest position relative to second frame assembly 301 when fluid tank 100 is in storage or when fluid tank 100 is in active use on mobile equipment. Also shown in FIG. 12 is relative fluid level 218 using the word “FULL” located on shaft 212. The portion of the word “FULL” that is observable indicates the relative level of fluid in the container.

FIG. 13 presents a detailed view of the third embodiment that illustrates how numeric indicia may be added to float assembly 206 so that the user is presented with additional information about the fluid level in the tank. Referring to FIG. 13, indicia such as inch ticks may be added to shaft 212 to assist in indicating the relative fluid level 218 of fluid in fluid container 102. Referring to FIG. 13, first tick mark 502, second tick mark 504, and third tick mark 506 with numeric indicia “3”, “2”, and “1” respectively positioned on the shaft 212, indicate the relative fluid level 218. Additional indicia such as colored bands e.g. a red band 514, a yellow band 516, and a green band 518 may also be used to indicate the relative fluid level. Although FIG. 13 indicates the use of indicia with the third embodiment, the same concept may be used to apply indicia to the first and second embodiments.

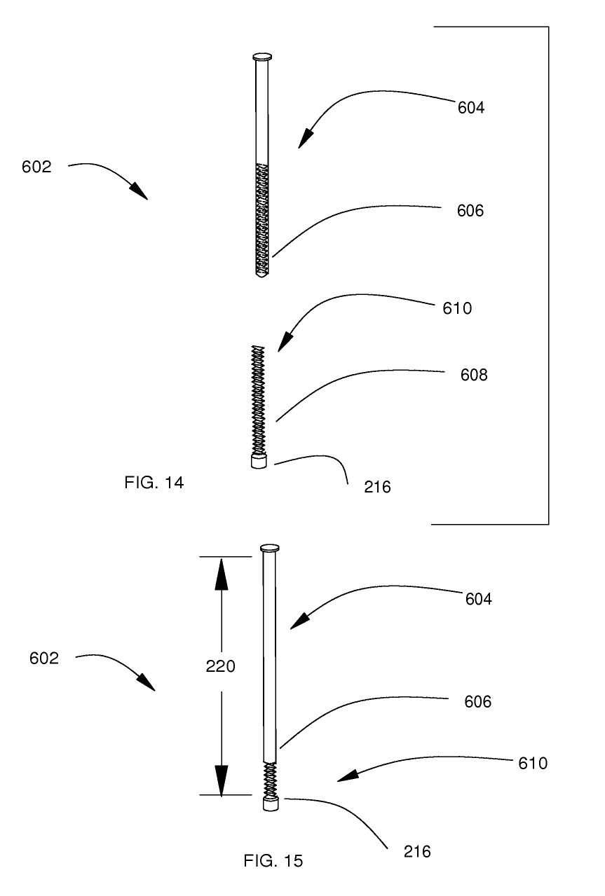

FIGS. 14 and 15 illustrates a fourth embodiment, a variation of the third embodiment. By modifying the float assembly 206 so that the position of float 216 on shaft 212 may be adjusted when the fluid level indicator device is first installed, the relative fluid level 218 may be made equal to the actual fluid level 112. Referring to FIGS. 14 and 15, float assembly 206 is replaced by adjustable float assembly 602. Adjustable float assembly 602 has an upper component 604 having second female threads 606, and a lower component 610 having a float 216 attached to second male threads 608 that are matched to second female threads 606.

Refer now to FIGS. 2, 6, 14 and 15. Using the adjustable float assembly 602 replacing the float assembly 206, the relative fluid level 218 may be set to the actual fluid level 112 upon installation. Use of a dip stick (not shown in the figures) may be used to add the amount of fluid in the fluid tank so the actual fluid level 112 is one inch. Then the shaft length 220 (see FIGS. 5, 15) may be adjusted so relative fluid level 218 is equal to the actual fluid level 112.

The disclosure presented herein gives multiple embodiments of the present invention. These embodiments are to be considered only as illustrative of the invention and not a limitation of the scope of the present invention. Various permutations, combinations, variations, and extensions of these embodiments are considered to fall within the scope of this invention.

What is claimed is:

1. A fluid level indicator device for use with a fluid tank, the fluid tank having a fluid fill nozzle, the fluid tank accommodating a quantity of fluid, the fluid level indicator device comprising:
a first frame assembly having a guide with a guide upper lip, the first frame assembly removably attachable to the fluid fill nozzle;
a float assembly comprising a float and a shaft, the shaft having a crown, the float assembly being slidingly attached to the guide such that when the first frame assembly is attached to the fluid fill nozzle, and the quantity of fluid is added to the fluid tank, then the shaft has a portion between the crown and the guide upper lip that is observable.

2. A fluid level indicator device for use with a fluid tank, the fluid tank having a fluid container and a fluid fill nozzle, the fluid fill nozzle being attached to the fluid container, the fluid fill nozzle having a fluid fill nozzle rim and a nozzle interior surface, the fluid tank accommodating a quantity of fluid, the fluid level indicator device comprising:
a first frame assembly comprising:
a curved rectangular strip, the curved rectangular strip being made of a springy material, the curved rectangular strip having at least one tab joined to the curved rectangular strip;
a guide attached to the curved rectangular strip, the guide having a guide upper lip such that when the curved rectangular strip is placed in the nozzle interior surface, and at least one tab is positioned on the fluid fill nozzle rim, the first frame assembly is secured to the nozzle interior surface; and
a float assembly comprising:
a float;
a shaft having a shaft first end and a shaft second end;
the shaft first end having a crown, the shaft second end being attached to the float;
the fluid level indicator device being sized and configured so that:
the first frame assembly may be removably secured to the fluid fill nozzle with at least one tab resting on the fluid fill nozzle rim;
the shaft of the float assembly is slidingly secured by the guide such that when the first frame assembly is installed in the fluid fill nozzle, and the quantity of fluid is added to the fluid tank, then the shaft may slide within the guide, and the shaft has a portion between the crown and the guide upper lip that is observable.

3. The fluid level indicator device of claim 2 wherein:
the shaft has indicia that indicates the distance between the crown and the guide upper lip.

4. The fluid level indicator device of claim 2 wherein:
the fluid container has a bottom interior surface;
the distance of the float from the bottom interior surface is dependent on the quantity of fluid.

5. The fluid level indicator device of claim 4 wherein:
the shaft is comprised of an upper component and a lower component;
the shaft has a length;
the upper component and the lower component being adjustably mated wherein the length of the shaft may be adjusted so that the distance between the crown and the guide upper lip may be set equal to the distance of the float to the bottom interior surface.

6. The fluid level indicator device of claim 4 wherein:
the shaft has a male set of threads,
the guide has a female set of threads matching the male set of threads wherein the float assembly may be secured to the first frame assembly by engaging the female set of threads to the male set of threads.

7. A fluid level indicator device for use with a fluid tank, the fluid tank having a fluid container and a fluid fill nozzle, the fluid fill nozzle having a threaded cap, the fluid fill nozzle having external threads mated to the threaded cap, the fluid fill nozzle being attached to the fluid container, the fluid tank accommodating a quantity of fluid, the fluid level indicator device comprising:
a second frame assembly comprising:
an angular hollow tube;
the angular hollow tube having an angular tube top end having angular tube external threads adapted to mate the threaded cap;
a threaded slip rotationally attached to the angular hollow tube;
the threaded slip and having internal threads adapted to mate with the external threads located on the fluid fill nozzle;
a narrow hollow tube mounted vertically and passing through the angular hollow tube;
the narrow hollow tube functioning as a guide having a guide upper lip'
a float assembly comprising:
a float;
a shaft having a shaft first end and a shaft second end;
the shaft first end having a crown, the shaft second end being attached to the float;
the fluid level indicator device being sized and configured so that:
the second frame assembly may be removably secured to the fluid fill nozzle using the threaded slip;
the shaft of the float assembly is slidingly secured by the guide such that when the second frame assembly is installed in the fluid fill nozzle, and the quantity of fluid is added to the fluid tank, then the shaft may slide within the guide, an the shaft has a portion between the crown and the guide upper lip that is observable.

8. The fluid level indicator device of claim 7 wherein:
the shaft has indicia that indicates the distance between the crown and the guide upper lip.

9. The fluid level indicator device of claim 8 wherein:
the fluid container has a bottom interior surface;
the distance of the float from the bottom interior surface is depends on the quantity of fluid.

10. The fluid level indicator device of claim 9 wherein:
the shaft is comprised of an upper component and a lower component;
The shaft has a length;
the upper component and the lower component being adjustably mated wherein the length of the shaft may be adjusted so that the distance between the crown and the guide upper lip may be set equal to the distance of the float to the bottom interior surface.

11. The fluid level indicator device of claim 8 wherein:
the shaft has a male set of threads;
the guide has a female set of threads matching the male set of threads wherein the float assembly may be secured to the second frame assembly by engaging the female set of threads to the male set of threads.
